(19) United States
(12) Patent Application Publication
(10) Pub. No.: US 2019/0196683 A1
(43) Pub. Date: Jun. 27, 2019

(54) ELECTRONIC DEVICE AND CONTROL METHOD OF ELECTRONIC DEVICE

(71) Applicant: SAMSUNG ELECTRONICS CO., LTD., Suwon-si, Gyeonggi-do (KR)

(72) Inventors: Mi Youn WON, Seoul (KR); Na Young KOH, Seoul (KR); Hyun Jee KWAK, Seoul (KR); Ji Hyae KIM, Seoul (KR); Seung Min LEE, Gwacheon-si, Gyeonggi-do (KR); Won Hee LEE, Seoul (KR); Woo Seok HWANG, Seoul (KR)

(21) Appl. No.: 16/098,982

(22) PCT Filed: Apr. 13, 2017
(86) PCT No.: PCT/KR2017/004027

§ 371 Date: Nov. 5, 2018

Related U.S. Application Data
(60) Provisional application No. 62/331,058, filed on May 3, 2016.

(30) Foreign Application Priority Data
Jan. 25, 2017 (KR) 10-2017-0011928

(51) Int. Cl. G06F 3/0486; G06F 3/16; G06F 3/0482

(52) U.S. Cl. CPC G06F 3/0486; G06F 3/0482; G06F 3/167

(57) ABSTRACT

An electronic device may include a display, and a processor. The processor may display an execution screen of a first application in the display, may change the execution screen of the first application to an execution screen of a second application, and may display a first object provided by the first application on the execution screen of the second application.

### TECHNICAL FIELD

The present disclosure relates to an electronic device including a display and a method of controlling the electronic device through a user interface displayed in a display.

### BACKGROUND ART

Various types of electronic products are being developed and supplied as digital technologies develop, and products which provide many services through various applications are appearing as functions of electronic products diversify.

Also, a service which may be provided in conjunction with any other electronic device is increasing as communication technologies develop. In particular, a service which utilizes various devices put in home of a user over a home network is also being developed.

### DISCLOSURE

### Technical Problem

In the case of changing an application while using content through the application or in the case of intending to use a function which the application does not provide, a plurality of operations such as an operation of turning off a current application execution screen and an operation of executing any other application are required, thereby making the user inconvenient.

Various embodiments of the present disclosure are to provide an electronic device which may control a plurality of functions which a first application provides through an object displayed in an execution screen of a second application and a controlling method thereof.

### Technical Solution

In accordance with various embodiments of the present disclosure, an electronic device may include a display, and a processor configured to display an execution screen of a first application in the display, to change the execution screen of the first application to an execution screen of a second application, and to display a first object provided by the first application on the execution screen of the second application. The first object may be an object for controlling a plurality of functions which are provided by the first application with regard to the second application.

In accordance with various embodiments of the present disclosure, a controlling method of an electronic device may include displaying an execution screen of a first application in a display, changing the execution screen of the first application to an execution screen of a second application, and displaying a first object provided by the first application on the execution screen of the second application. The first object may be an object for controlling a plurality of functions which are provided by the first application with regard to the second application.

In accordance with various embodiments of the present disclosure, a computer-readable recording medium may store a program performing a method that includes displaying an execution screen of a first application in a display, changing the execution screen of the first application to an execution screen of a second application, and displaying a first object provided by the first application on the execution screen of the second application. The first object may be an object for controlling a plurality of functions which are provided by the first application with regard to the second application.

### Advantageous Effects

According to various embodiments of the present disclosure, a plurality of functions which are provided by a second application may be controlled through an object provided by a first application in an execution screen of the second application. As such, a user may control an electronic device conveniently without switching an application execution screen.

### DESCRIPTION OF DRAWINGS

FIG. 1 is a view illustrating a network system according to various embodiments of the present disclosure;

FIG. 2 is a block diagram illustrating a configuration of a first electronic device according to various embodiments of the present disclosure;

FIG. 3 is a view illustrating a method of executing a second application according to various embodiments of the present disclosure;

FIG. 4 is a view illustrating a method of changing a first object according to various embodiments of the present disclosure;

FIG, 5 is a view illustrating a function provided through a first object according to various embodiments of the present disclosure;

FIG. 6 is a view illustrating a function provided through a first object according to various embodiments of the present disclosure;

FIG. 7A is a view illustrating a function provided through a first object according to various embodiments of the present disclosure;

FIG. 7B is a view illustrating a method of outputting content through grounded external electronic devices according to various embodiments of the present disclosure;

FIG. 7C is a view illustrating a function provided through a first object according to various embodiments of the present disclosure;

FIG. 8 is a view illustrating a function provided through a first object according to various embodiments of the present disclosure;

FIG. 9 is a view illustrating a function provided through a first object according to various embodiments of the present disclosure;

FIG. 10 is a view illustrating a method of deleting a first object according to various embodiments of the present disclosure;

FIG. 11 is a view illustrating a function of selecting an external electronic device which will output content according to various embodiments of the present disclosure;

FIG. 12 illustrates a function of providing a notification according to various embodiments of the present disclosure;

FIG. 13 is a view illustrating an execution screen of a first application according to various embodiments of the present disclosure;

FIG. 14 is a view illustrating an execution screen of a first application according to various embodiments of the present disclosure;

FIG. 15 is a view illustrating an execution screen of a first application according to various embodiments of the present disclosure;

FIG. 16 is a view illustrating an execution screen of a first application according to various embodiments of the present disclosure; and

FIG. 17 is a flowchart illustrating a controlling method of a first electronic device according to various embodiments of the present disclosure.

### MODE FOR INVENTION

Hereinafter, various embodiments of the present disclosure will be described with reference to accompanying drawings. However, those of ordinary skill in the art will recognize that modification, equivalent, and/or alternative on various embodiments described herein can be variously made without departing from the scope and spirit of the present disclosure. With regard to description of drawings, similar components may be marked by similar reference marks/numerals.

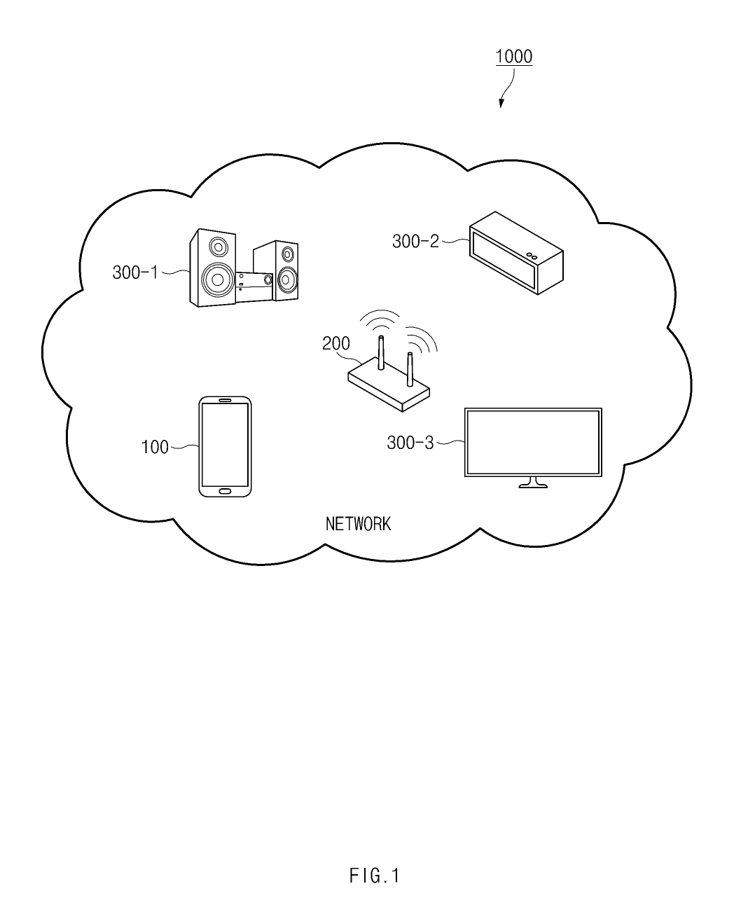

FIG. 1 is a view illustrating a network system according to various embodiments of the present disclosure.

According to an embodiment, a network system 1000 may include a first electronic device 100, a second electronic device 200, and at least one (e.g., a plurality of) third electronic device 300-1, 300-2, or 300-3.

According to an embodiment, the first electronic device 100, the second electronic device 200, and the at least one third electronic device 300-1, 300-2, or 300-3 may be connected to each other over a network. For example, the first electronic device 100 the second electronic device 200, the third electronic device 300-1, 300-2, or 300-3 may be connected to each other over a wired or wireless network. For example, the network may be a home network.

According to an embodiment, the first electronic device 100 may be a portable electronic device. For example, the first electronic device 100 may include a smartphone or a tablet PC. According to an embodiment, the first electronic device 100 may transmit content (e.g., video, audio, or the like) to an external electronic device (e.g., the third electronic device 300-1, 300-2, or 300-3) over the network. According to an embodiment, the first electronic device 100 may control the external electronic device (e.g., the third electronic device 300-1, 300-2, or 300-3) over the network. For example, the first electronic device 100 may provide a user interface to a user through an application, and may control the external electronic device depending on a user input received through the user interface.

According to an embodiment, the second electronic device 200 may be a network device. For example, the second electronic device 200 may be a device, which connects different networks or connects a plurality of electronic devices the first electronic device 100 and the third electronic device 300-1, 300-2, or 300-3), such as an access point (AP) or a router.

According to an embodiment, the third electronic device 300-1, 300-2, or 300-3 may be a content output device. For example, the third electronic device 300-1, 300-2, or 300-3 may be a device, which includes a display or audio device, such as a TV, a speaker, or the like. According to an embodiment, the third electronic device 300-1, 300-2, or 300-3 may output content received from the first electronic device 100 under control of the first electronic device 100.

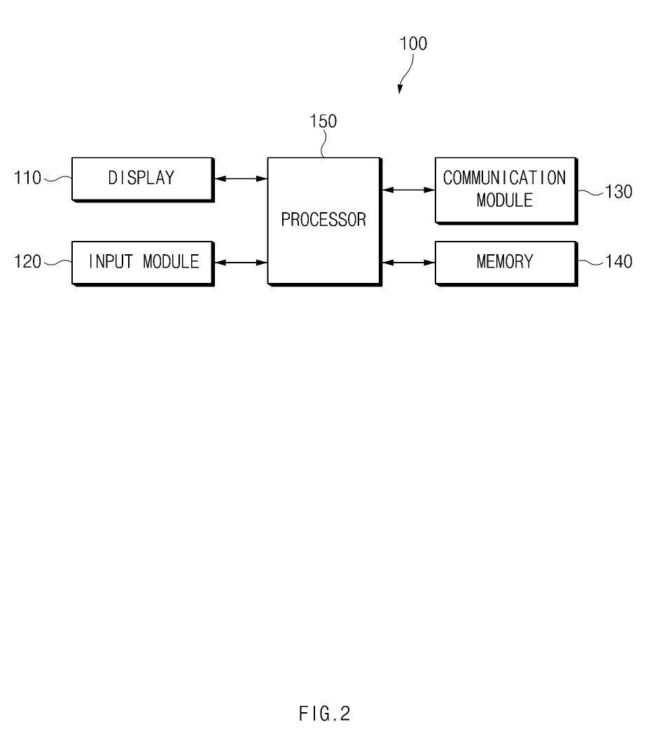

FIG. 2 is a block diagram illustrating a configuration of a first electronic device according to various embodiments of the present disclosure.

According to an embodiment, the first electronic device 100 may include a display 110, an input module 120, a communication module 130, a memory 140, and a processor 150.

According to an embodiment, the display 110 may display an execution screen of an application. For example, when a first application is executed, the display 110 may display a first user interface which is provided by the first application. For another example, when a second application is executed, the display 110 may display a second user interface which is provided by the second application.

According to an embodiment, the input module 120 may receive a user input. According to an embodiment, the input module 120 may include a touch sensor panel which senses a touch manipulation of the user or a pen sensor panel which senses a pen manipulation of the user. According to an embodiment, the input module 120 may include a voice recognition sensor which recognizes a voice of the user or a motion recognition sensor which recognizes a gesture of the user.

According to an embodiment, the display 110 and the input module 120 may be implemented with a touchscreen in which an input panel is positioned on a display panel so as to simultaneously perform sensing of a touch manipulation and displaying.

According to an embodiment, the communication module 130 may communicate with an external electronic device (e.g., the third electronic device 300-1, 300-2, or 300-3. According to an embodiment, the communication module 130 may transmit a control signal for controlling the external electronic device to the external electronic device. According to an embodiment, the communication module 130 may include a cellular module, a wireless-fidelity (Wi-Fi) module, or a Bluetooth module.

According to an embodiment, the memory 140 may store an application and a user interface. For example, the memory 140 may store a first application which controls an external electronic device for outputting content provided by at least one second application and the at least one second application which provides the content. According to an embodiment, the first application may be an application for selecting the at least one second application, the content, or the external electronic device for outputting the content. According to an embodiment, the second application may be an application which provides audio or video content such as music, the radio, a movie, a drama, or the like. For example, the second application may be an application which receives audio or video content from an external server (e.g., a content provider server) and plays the received content. For another example, the second application may be an application which manages content stored in an internal storage device (e.g., the memory 140) or an external storage device (e.g., a cloud server or the like). According to an embodiment, the memory 140 may store a first user interface which is provided by the first application and a second user interface which is provided by the second application.

According to an embodiment, the processor 150 may control overall operations of the first electronic device 100. For example, the processor 150 may control the display 110, the input module 120, the communication module 130, and the memory 140 respectively such that an execution screen (or a user interface) of an application according to various embodiments of the present disclosure is displayed and various functions are provided to the user through an object included in the execution screen of the application.

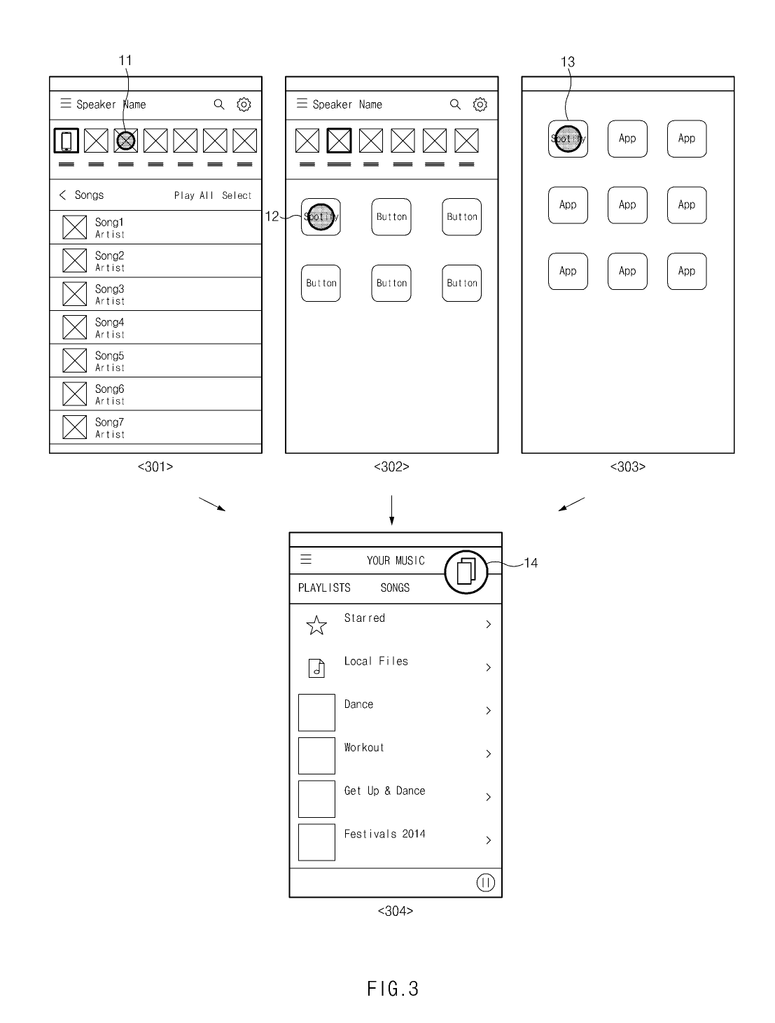

According to an embodiment, the first electronic device 100 may include the at least one processor 150. According to an embodiment, the processor 150 may be implemented with a system on chip (SoC) which includes a central processing unit (CPU), a graphic processing unit (GPU), a memory, or the like. Below, an operation of the processor 150 will be described with reference to FIGS. 3 to 16.

FIG, 3 is a view illustrating an execution method of a second application according to various embodiments of the present disclosure.

Referring to image <301> and image <302> of FIG. 3, the processor 150 may display an execution screen of a first application in the display 110. For example, when a user input to a first application icon is received, the processor 150 may execute the first application and may display the execution screen of the first application in the display 110. When a user input to a second application icon 11 or 12 included in the execution screen of the first application is received, the processor 150 may execute the second application.

Referring to image <303> of FIG. 3, when a user input to a second application icon 13 included in a home launcher is received, the processor 150 may execute the second application.

Referring to image <304> of FIG. 3, when the second application is executed, the processor 150 may display an execution screen of the second application in the display 110. For example, the processor 150 may change the execution screen of the first application displayed in the display 110 to the execution screen of the second application. According to an embodiment, the processor 150 may display a first object 15 which is provided by the first application, on the execution screen of the second application. The first object 15 may be, for example, a floating user interface (UI) for providing a plurality of functions which are provided by the first application. For example, the plurality of functions may include a first function of changing an application execution screen, a second function of controlling at least one external electronic device for outputting content which is provided by the second application, a third function of recognizing a voice, and a fourth function of changing an environment setting value of an electronic device. The second function of controlling the at least one external electronic device may include at least one of the following functions: a function of changing a name of the at least one external electronic device, a function of grouping a plurality of external electronic devices, and a function of removing the grouping, and a function of changing an external electronic device included in a group.

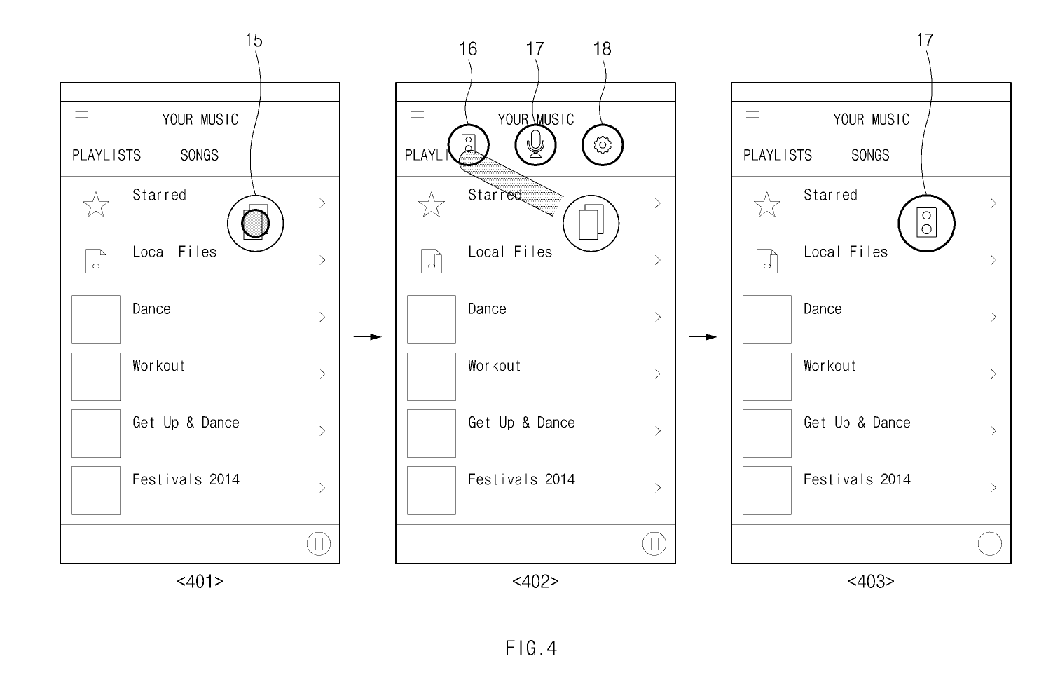

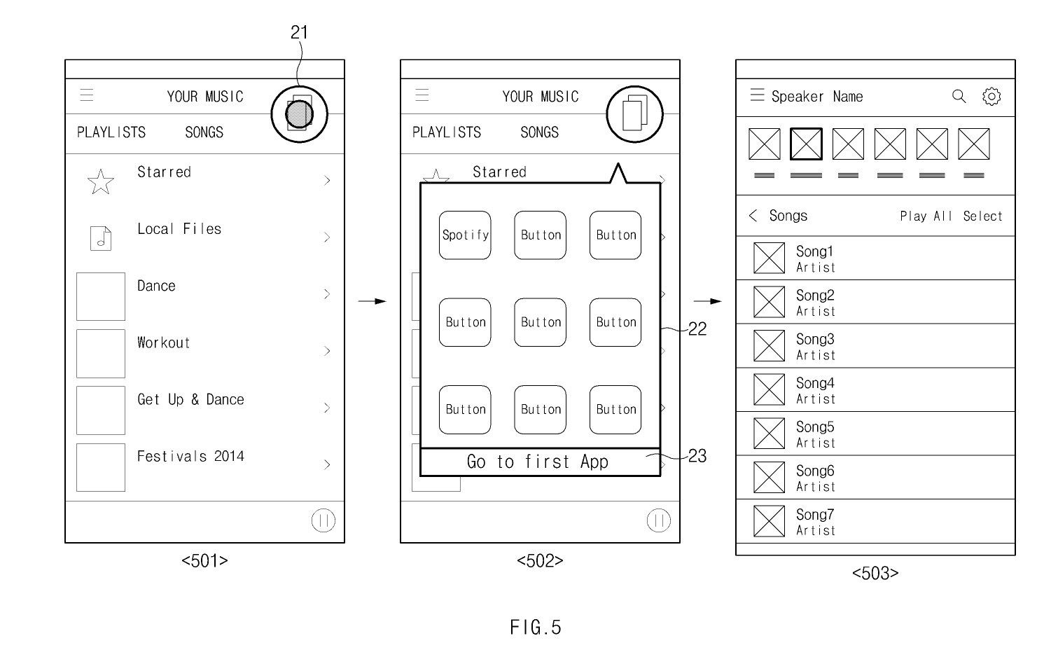

FIG. 4 is a view illustrating a method of changing a first object according to various embodiments of the present disclosure.

According to an embodiment, a first object which is provided by the first application may include a plurality of first objects corresponding to a plurality of functions which are provided by the first application. According to an embodiment, the processor 150 may select one of the plurality of functions provided by the first application. For example, the processor 150 may select a specified function by default or may select a function which the user lastly selects. According to an embodiment, the processor 150 may display an object, which corresponds to the selected function, from among the plurality of first objects in the display 110. For example, referring to image <401> of FIG. 4, the processor 150 may display the first object 15 corresponding to the first function.

According to an embodiment, when a specified user input (e.g., long tap) to the first object 15 corresponding to the first function is received, the processor 150 may additionally display a plurality of first objects 16, 17, and 18 corresponding to the plurality of functions which are provided by the first application. For example, referring to image <402>, the processor 150 may additionally display the first object 16 corresponding to the second function, the first object 17 corresponding to the third function, and the first object 18 corresponding to the fourth function in the display 110. According to an embodiment, the processor 150 may receive a user input selecting one of the plurality of first objects 15, 16, 17, and 18. For example, a long tap input to the first object 15 corresponding to the first function may be received, may be moved to the first object 16 corresponding to the second function, and may be released (drag and drop). For another example, the processor 150 may receive a tap input to the first object 16 corresponding to the second function after the long tap input to the first object 15 corresponding to the first function is released.

According to an embodiment, when the user input selecting one of the plurality of first objects 15, 16, 17, and 18 is received, the processor 150 may display a first object, which is selected by the user, from among the plurality of first objects 15, 16, 17, and 18 in the display 110 and may delete unselected first objects from the display 110. For example, referring to image <403> of FIG. 4, the processor 150 may change the first object 15 corresponding to the first function to the first object 16 corresponding to the third function selected by the user, and may delete the unselected first objects 15, 17, and 18 from a display screen.

FIG. 5 is a view illustrating a function provided through a first object according to various embodiments of the present disclosure.

According to an embodiment, the processor 150 may provide a first function of changing an execution screen of an application through a first object provided by the first application. For example, referring to image

of FIG. 5, the processor 150 may display a first object 21 corresponding to the first function on the execution screen of the second application. Referring to image <502>, when a user input (e.g., a tap input) to the first object 21 is received, the processor 150 may display a second object 22 provided by the first application in the display 110. The second object 22 may include a menu 23 for displaying the execution screen of the first application. Referring to image <503>, when a user input to the menu 23 for displaying the execution screen of the first application is received, the processor 150 may change the execution screen of the second application displayed in the display 110 to the execution screen of the first application. When the execution screen of the first application is displayed, the processor 150 may delete the first object 21 which the first application provides, from a display screen.

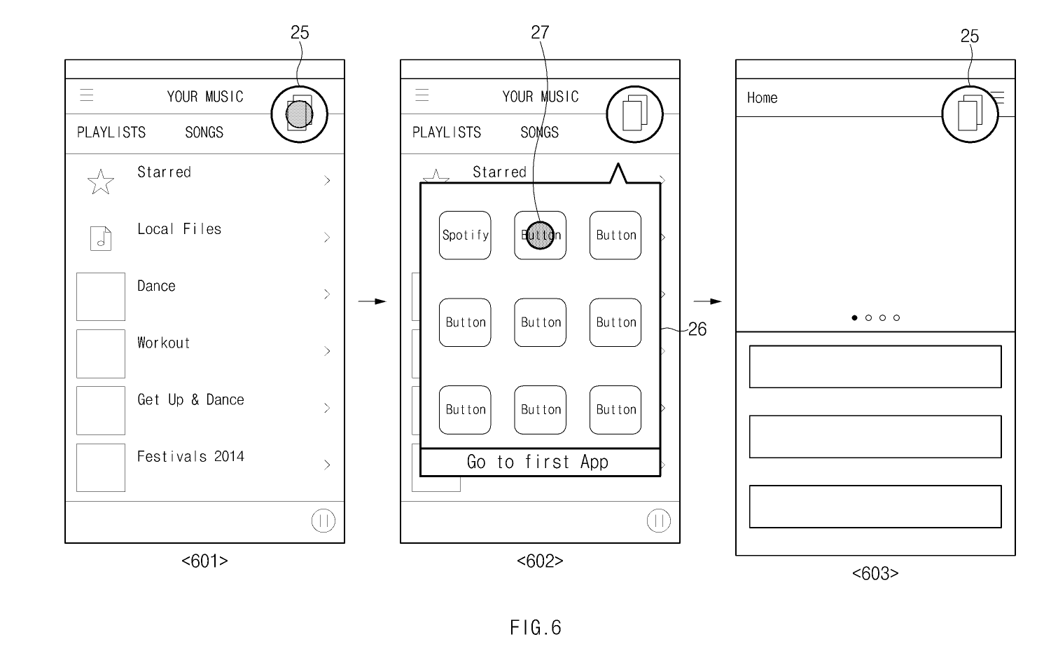

FIG. 6 is a view illustrating a function provided through a first object according to various embodiments of the present disclosure.

According to an embodiment, the processor 150 may provide a function of changing an application execution screen through a first object provided by the first application. For example, referring to image <601> of FIG. 6, the processor 150 may display a first object 25 on the execution screen of the second application. Referring to image <602>, when a user input (e.g., a tap input) to the first object 25 is received, the processor 150 may display a second object 26 in the display 110. The second object 26 may include a plurality of icons corresponding to a plurality of second applications providing content. The plurality of second applications may be, for example, an application which provides content in conjunction with the first application. Referring to image <603>, when a user input to one 27 of the plurality of icons is received, the processor 150 may display an execution screen of any other second application corresponding to the icon 27 to which the user input is received, instead of the execution screen of the second application displayed in the display 110. Even though an execution screen of an application is changed, the processor 150 may maintain the first object 25 which the first application provides, without deletion.

According to the embodiment described with reference to FIGS. 5 and 6, the user may change an application execution screen conveniently by using the first object 21 or 25.

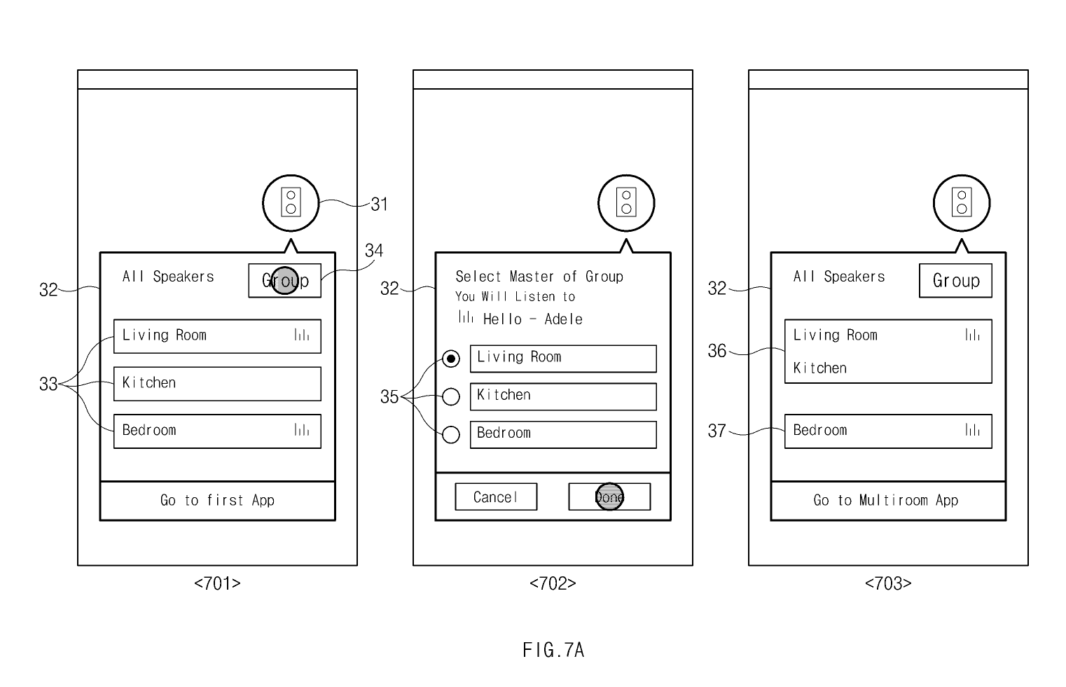

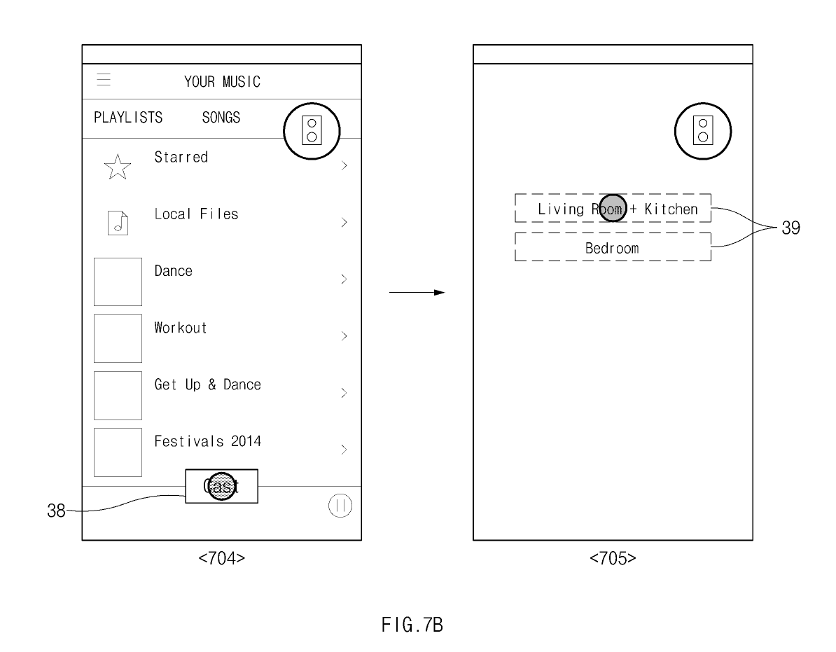

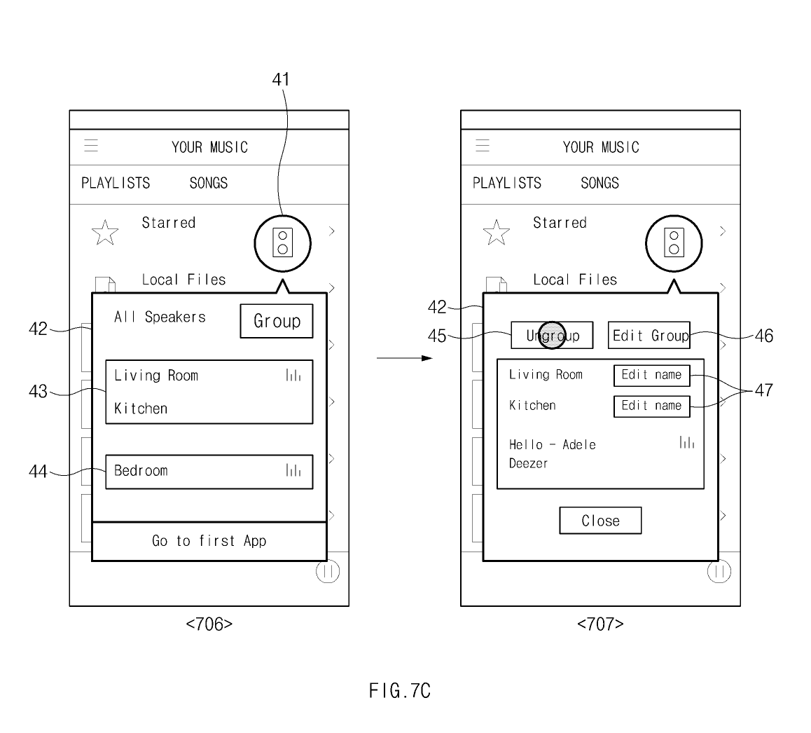

FIG. 7A is a view illustrating a function provided through a first object according to various embodiments of the present disclosure.

According to an embodiment, the processor 150 may provide a function of controlling an external electronic device through a first object provided by the first application. According to an embodiment, the external electronic device which is controlled through the first object may be an electronic device which is registered at the first application. For example, referring to image <701> of FIG. 7A, the processor 150 may display a first object 31 on the execution screen of the second application. When a user input (e.g., a tap input) to the first object 31 is received, the processor 150 may display a second object 32 provided by the first application in the display 110. The second object 32 may include an external electronic device list 33 and a group menu 34 providing a function of grouping external electronic devices. Referring to image <702>, When a user input (e.g., a tap input) to the group menu 34 is received, the processor 150 may display a select menu 35 which may select an external electronic device targeted for grouping, in the second object 32. According to an embodiment, the user may select an external electronic device targeted for grouping among a plurality of external electronic devices by using the select menu 35. For example, the user may sequentially select a main device (or a master device) and a sub device (o slave device) from a plurality of electronic devices to be grouped. Referring to image <703>, when an external electronic device targeted for grouping is selected, the processor 150 may display a list of external electronic devices included in the second object 32 for each group. For example, the processor 150 may separately display an external electronic device list 36 included in a first group and an external electronic device list 37 included in a second group.

FIG. 7B is a view illustrating a method of outputting content through grounded external electronic devices according to various embodiments of the present disclosure.

Referring to image <704> of FIG. 7B, the execution screen of the second application may include a content play menu :38, Referring to image <705>, when a user input to the content play menu 38 is received, the processor 150 may display a list 39 of external electronic devices which may play content, in the display 110. In the case where a grouped external electronic device exists, the processor 150 may display an external electronic device list for each group. According to an embodiment, when a user input selecting one external electronic device in the external electronic device list 39 is received, the processor 150 may transmit content to the selected external electronic device (or a selected group).

FIG. 7C is a view illustrating a function provided through a first object according to various embodiments of the present disclosure.

According to an embodiment, the processor 150 may provide a function of controlling an external electronic device through a first object provided by the first application. According to an embodiment, the external electronic device which is controlled through the first object may be an electronic device which is registered at the first application. For example, referring to image <706> of FIG. 7C, the processor 150 may display a first object 41 provided by the first application oil the execution screen of the second application. When a user input (e.g., a tap input) to the first object 41 is received, the processor 150 may display a second object 42 in the display 110. The second object 42 may include external electronic device lists 43 and 44. In the case where a grouped external electronic device exists, the external electronic device lists 43 and 44 may be displayed for each group. Referring to image <707>, when a user input e.g., a tap input) to the grouped external electronic device list 43 is received, an ungroup menu 45, a group edit menu 46 providing a function of changing an external electronic device included in a group, and a name edit menu 47 changing a name of an external electronic device included in a group may be displayed in the second object 42. The ungroup menu 45 may provide a function of ungrouping an external electronic device. The group edit menu 46 may provide a function of adding a new external electronic device to a group or excluding a part of external electronic devices included in a group. The name edit menu 47 may provide a function of changing a name of an external electronic device.

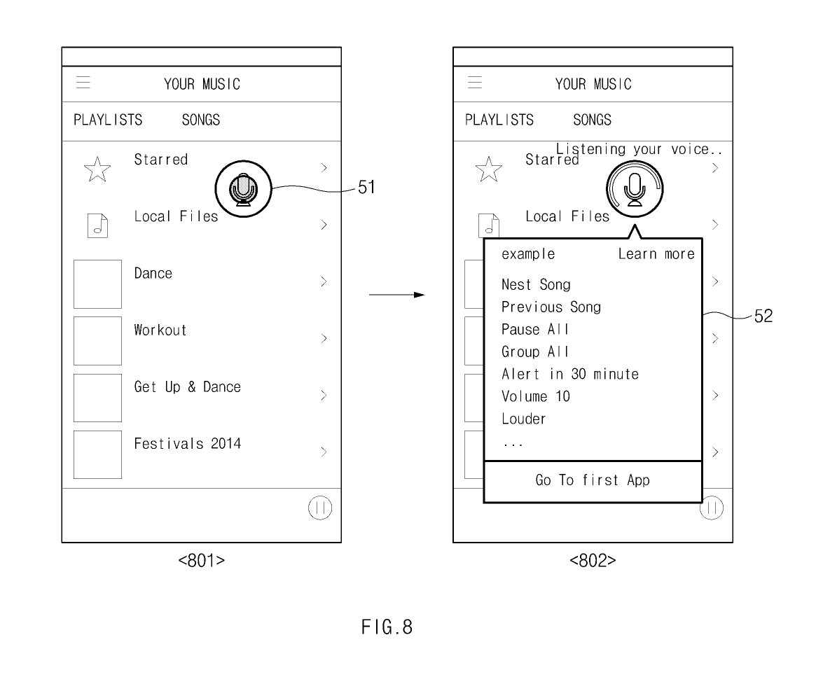

FIG. 8 is a view illustrating a function provided through a first object according to various embodiments of the present disclosure.

According to an embodiment, the processor 150 may provide a voice recognition function through a first object provided by the first application. For example, referring to image <801> of FIG. 8, the processor 150 may display a first object 51 provided by the first application on the execution screen of the second application. Referring to image <802>, when a user input (e.g., a tap input) to the first object 51 is received, the processor 150 may activate a voice recognition function. When the user input (e.g., a tap input) to the first object 51 is received, the processor 150 may display a second object 52 in the display 110. The second object 52 may include information (e.g., an example of voice recognition) about voice recognition.

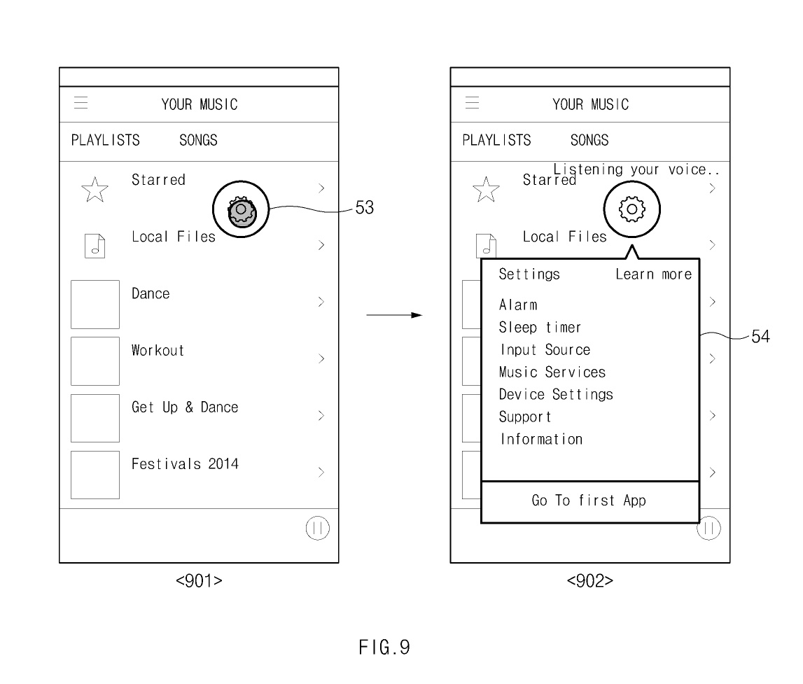

FIG. 9 is a view illustrating a function provided through a first object according to various embodiments of the present disclosure.

According to an embodiment, the processor 150 may provide a function of changing an environment setting value through a first object provided by the first application. For example, referring to image <901> of FIG. 9, the processor 150 may display a first object 53 provided by the first application on the execution screen of the second application. Referring to image <902>, when a user input (e.g., a tap input) to the first object 53 is received, the processor 150 may display a second object 54 in the display 110. The second object 54 may include a menu for changing an environment setting value of the electronic device 100. For example, the second object 54 may include a menu for providing the following functions: a function of setting an alarm, a function of setting an audio output value, and the like.

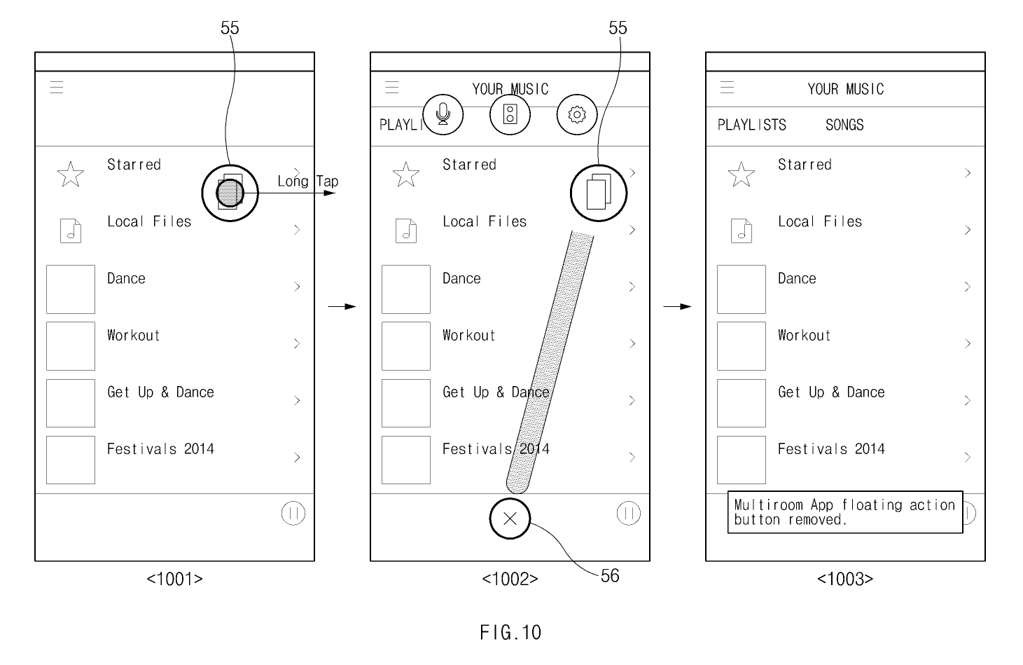

FIG. 10 is a view illustrating a method of deleting a first object according to various embodiments of the present disclosure.

Referring to image <1001> of FIG. 10, the processor 150 may display a first object 55 provided by the first application on the execution screen of the second application.

Referring to image <1002>, when a specified user input (e.g., a long tap) to the first object 55 is received, the processor 150 may additionally display a third object 56 for deleting the first object 55 from a display screen. According to an embodiment, the processor 150 may receive a user input selecting the third object 56. For example, a long tap input to the first object 55 may be released after being moved to the third object 56. For another example, the processor 150 may receive a tap input to the third object 56 after the long tap input to the first object 55 is released.

Referring to image <1003>, when the user input selecting the third object 56 is received, the processor 150 may delete the first object 55 from the display screen.

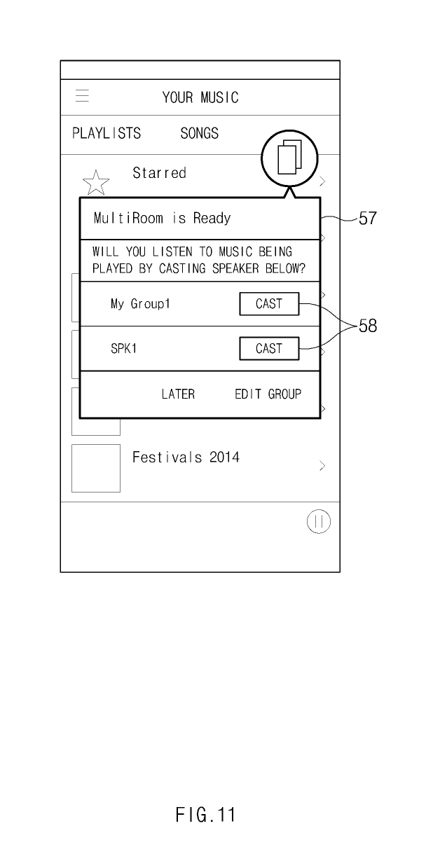

FIG. 11 is a view illustrating a function of selecting an external electronic device which will output content according to various embodiments of the present disclosure.

According to an embodiment, the processor 150 may be connected to at least one external electronic device registered at the first application over a network while the second application is executed. For example, a situation where the user arrives at home while listening to music through a speaker included in the electronic device 100 or an earphone by using the second application may occur. When the user arrives at home and the electronic device 100 is connected to a home network, the electronic device 100 may be connected to at least one speaker registered at the first application over the home network.

Referring to FIG. 11, when connected with at least one external electronic device registered at the first application over a network while the second application is executed, the processor 150 may display a second object 57 for selecting the at least one external electronic device which will output content, in the display 110. The second object 57 may include a list of external electronic devices connected over the network and a select menu 58 for selecting an external electronic device which will output content. In the case where a grouped external electronic device exists, the external electronic device list may be displayed for each group. When a user input to the select menu 58 is received, the processor 150 may transmit content provided by the second application to the selected external electronic device (or group).

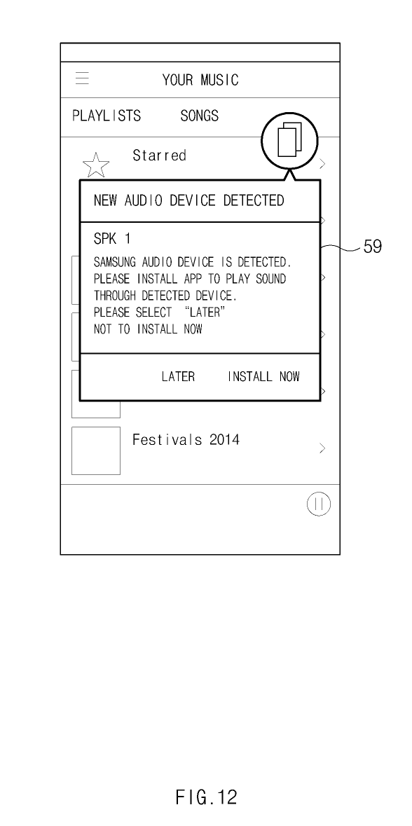

FIG. 12 illustrates a function of providing a notification according to various embodiments of the present disclosure.

According to an embodiment, the processor 150 may be connected to an external electronic device not registered at the first application over a network while the second application is executed. For example, in the case where the user purchases a new speaker and connects the new speaker to a home network, the electronic device 100 may be connected with the new speaker over the home network.

Referring to FIG. 12, when connected with the external electronic device not registered at the first application over a network while the second application is executed, the processor 150 may display a second object 59 providing notification that the registration of the unregistered external electronic device at the first application is possible. When a user input for registering the unregistered external electronic device is received through the second object 59 (e.g., when the user selects “Install Now”), the processor 150 may change the execution screen of the second application to the execution screen of the first application for the registration of the external electronic device.

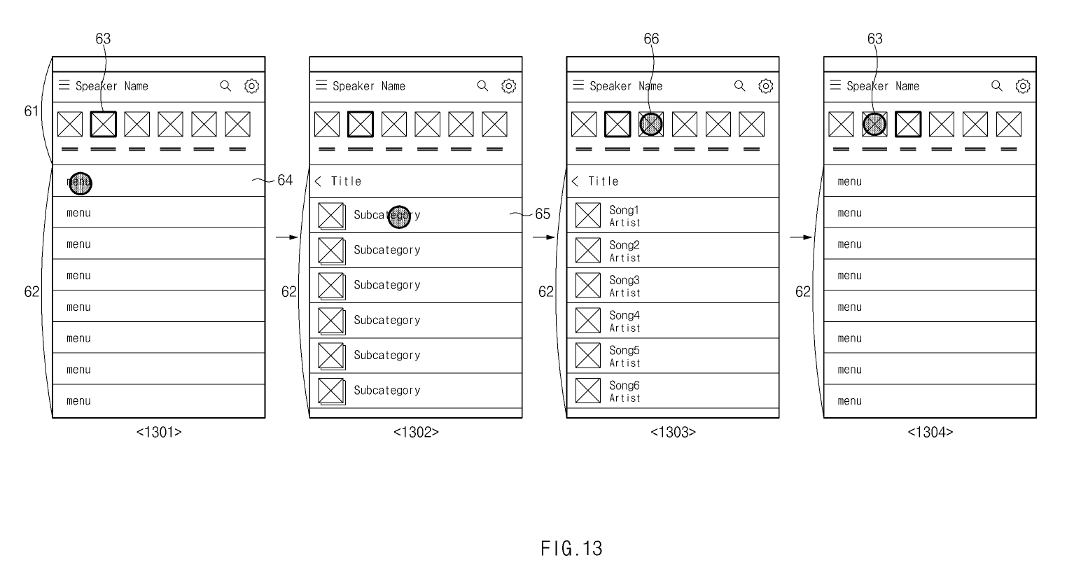

FIG. 13 is a view illustrating an execution screen of a first application according to various embodiments of the present disclosure.

Referring to image <1301> of FIG. 13, when the first application is executed, the processor 150 may display the execution screen of the first application in the display 110. According to an embodiment, the execution screen of the first application may include a first area 61 and a second area 62. The first area 61 may include, for example, a second application list. The second area 62 may be, for example, a browsing area which may select content or a function included in the second application. According to an embodiment, the second area 62 may include a menu associated with an application icon selected by the user among application icons included in the first area 61. For example, when a second icon 63 is selected by the user, the processor 150 may display a menu associated with the second icon 63 in the second area 62.

Referring to image <1302>, when one of menus included in the second area 62 and associated with the second application is selected, the processor 150 may display a sub menu associated with the selected menu in the second area 62. For example, when a user input to a first menu 64 is received, the processor 150 may display a sub menu of the selected menu 64 in the second area 62.

Referring to image <1303>, when one of sub menus associated with the second application is selected, the processor 150 may display a sub menu of the selected sub menu. For example, when a user input to a first sub menu 65 is received, the processor 150 may display a sub menu of the first sub menu 65 in the second area 62. According to an embodiment, the processor 150 may receive a user input to the second application list included in the first area 61 in browsing of the second area 62. For example, the processor 150 may receive a user input to a third icon 66 of application icons included in the second application list,

Referring to image <1304>, when the user input to the third icon 66 is received, the processor 150 may display a menu associated with the third icon 66 in the second area 62. For example, the processor 150 may change a browsing screen which is displayed in the second area 62 with regard to the second icon 63, to a browsing screen associated with the third icon 66.

When a user input to the second icon 63 of the application icons included in the second application list is received, like image <1301>, the processor 150 display a menu associated with the second icon 63 in the second area 62. Whenever an application icon included in the first area 61 is selected, the processor 150 may be a default menu (or a top-level menu) of the selected application icon in the second area 62.

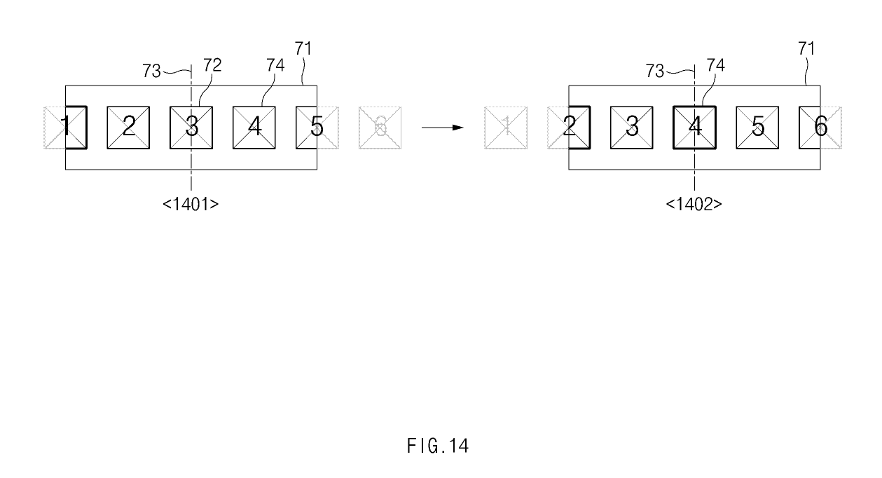

FIG. 14 is a view illustrating an execution screen of a first application according to various embodiments of the present disclosure.

According to an embodiment, the processor 150 may display a selected application icon (or an application icon being browsed) at the center of a first area upon displaying a second application list. For example, referring to image <1401> of FIG. 14, when a third icon 72 of a plurality of icons included in a first area 71 is selected, the third icon 72 may be displayed at the center of the first area 71. Referring to image <1402> of FIG. 14, when a fourth icon 74 of the plurality of icons included in the first area 71 is selected, the third icon 74 may be displayed at the center of the first area 71 by changing a location of the plurality of icons. The processor 150 may not change a sort order of the plurality of icons, but the processor 150 may change only a location where icons are displayed.

According to an embodiment, the processor 150 may sort icons included in the second application list depending on a specified order.

According to an embodiment, the processor 150 may sort icons depending on a use history of an application. For example, the processor 150 may sort icons in the order of recently used icons. For another example, the processor 150 may sort icons depending on a specified sort order (e.g., an order specified by the user). For another example, the processor 150 may sort icons depending on the specified sort order such that only an order (e.g., first) of the latest used icon is changed.

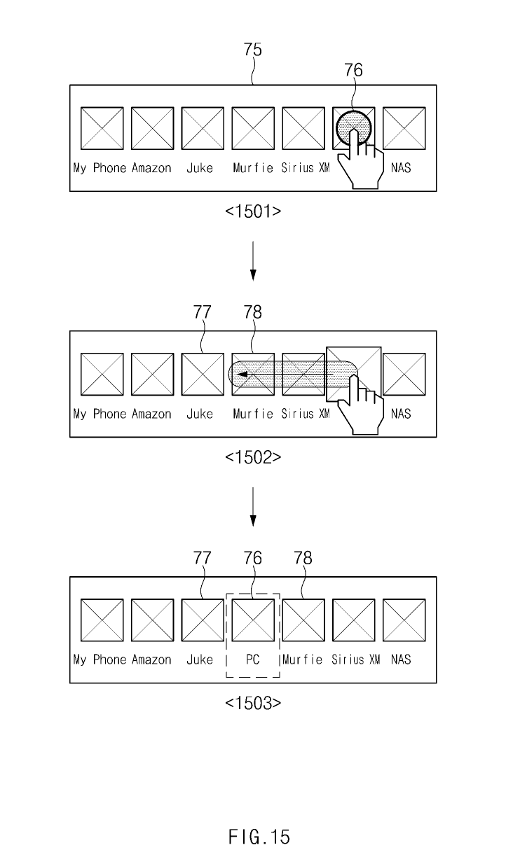

FIG. 15 is a view illustrating an execution screen of a first application according to various embodiments of the present disclosure.

According to an embodiment, the processor 150 may change a sort order of a second application list included in a first area 75. For example, referring to image <1501> to image <1503> of FIG. 15, when a specified user input (e.g., a long tap) to a sixth icon 76 of a plurality of icons is received, is dragged, and is dropped between a third icon 77 and a fourth icon 78, a location (or a sort order) of the sixth icon 76 may be changed to a space between the third icon 77 and the fourth icon 78.

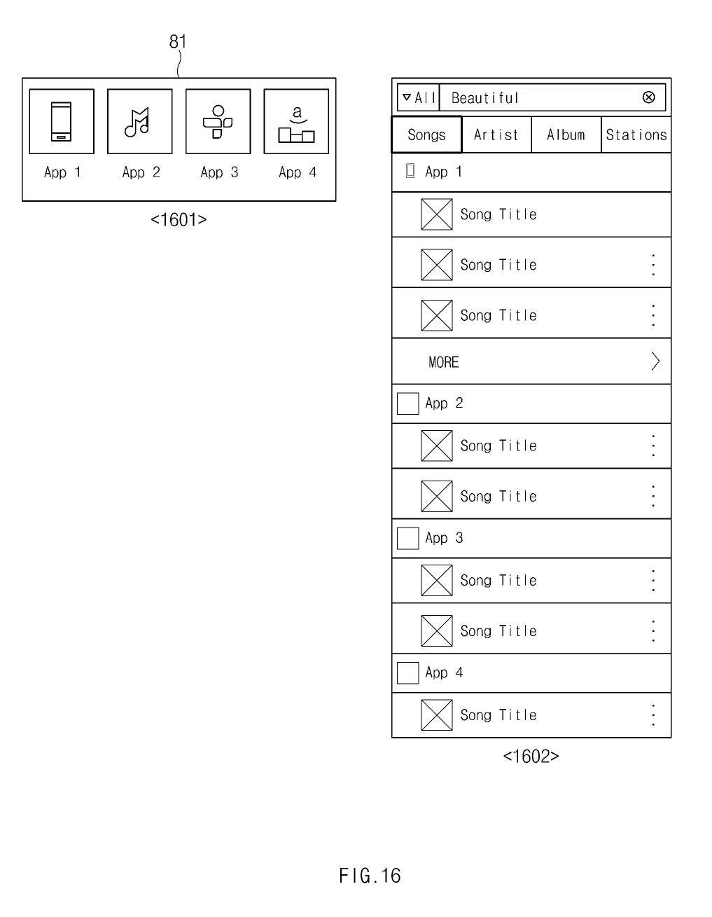

FIG. 16 is a view illustrating an execution screen of a first application according to various embodiments of the present disclosure.

According to an embodiment, the processor 150 may provide a search function through the execution screen of the first application. For example, the processor 150 may provide a content search function by a plurality of second applications through the execution screen of the first application. When a search word is input by the user, the processor 150 may provide a search result by the plurality of second applications. When a search word such as a song, an artist, an album, or the like is input, the processor 150 may provide a search result of each of the plurality of second applications on one screen.

According to an embodiment, the processor 150 may determine an order of providing a search result depending on at least one of a sort order of the second application list, a use history of the second application, and an execution state (e.g., whether account login is made). For example, referring to image <1601> of FIG. 16, the processor 150 may sort and display a plurality of second applications App1, App2, App3, and App4 in a first area 81 of the execution screen of the first application. Referring to image <1602>, the processor 150 may sort and display a result found through each of the second applications depending on a sort order of the second application list included in the first area, toward a lower end from an upper end. For another example, the processor 150 may display a result found by the latest used (or currently used) second application at the uppermost end, and may display results found by the remaining second applications depending on the sort order of the second application list included in the first area.

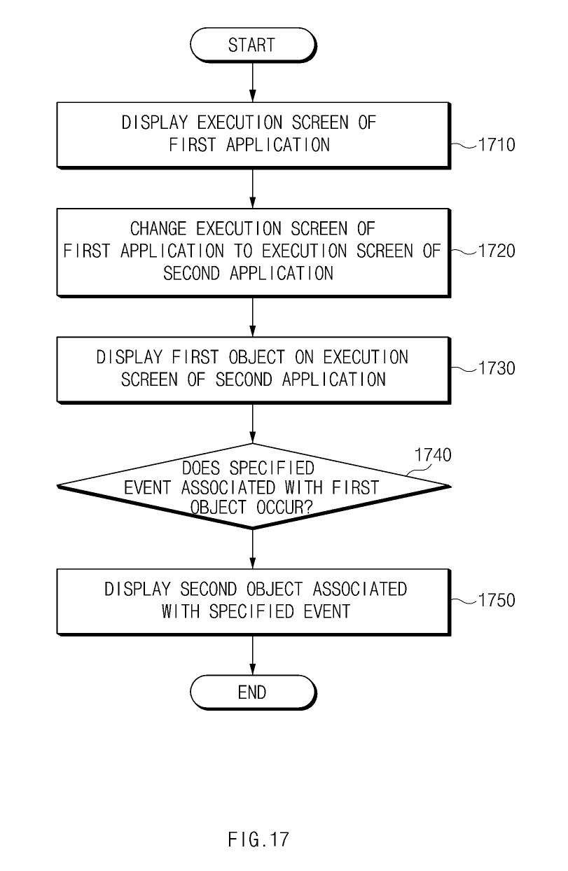

FIG. 17 is a flowchart illustrating a control method of a first electronic device according to various embodiments of the present disclosure.

The flowchart illustrated in FIG. 17 may include operations which are processed by the first electronic device 100 described above Even though omitted below, the description of the first electronic device 100 given with reference to FIGS. 1 to 16 may be applied to the flowchart illustrated in FIG. 7.

According to an embodiment, in operation 1710, the first electronic device 100 may display the execution screen of the first application in a display. For example, when a user input to a first application icon is received, the first electronic device 100 may execute the first application and may display the execution screen of the first application in the display. The first application may be, for example, an application controlling at least one external electronic device for outputting content provided by the second application.

According to an embodiment, in operation 1720, the first electronic device 100 may change the execution screen of the first application to the execution screen of the second application. For example, in a state where the execution screen of the first application is displayed, when a user input to a second application icon included in the execution screen of the first application is received, the first electronic device 100 may execute the second application. When the second application is executed, the first electronic device 100 may change the execution screen of the first application to the execution screen of the second application. The second application may be an application which provides audio or video content such as music, the radio, a movie, a drama, or the like.

According to an embodiment, in operation 1730, the first electronic device 100 may display a first object for controlling a plurality of functions to be provided by the first application on the execution screen of the second application. The first object may be, for example, a floating user interface (UI) for providing a plurality of functions which are provided by the first application. For example, the plurality of functions may include a first function of changing an application execution screen, a second function of controlling at least one external electronic device for outputting content which is provided by the second application, a third function of recognizing a voice, and a fourth function of changing an environment setting value of an electronic device. The second function of controlling the at least one external electronic device may include at least one of the following functions: a function of changing a name of the at least one external electronic device, a function of grouping a plurality of external electronic devices, and a function of removing the grouping, and a function of changing an external electronic device included in a group.

According to an embodiment, the first electronic device 100 may select one of the plurality of functions which are provided by the first application. According to an embodiment, the first electronic device 100 may display an object, which corresponds to the selected function, from among a plurality of first objects in the display 110. According to an embodiment, when a user input changing the selected function is received, the first electronic device 100 may display a first object, which corresponds to a changed function, from among the plurality of first objects.

According to an embodiment, in operation 1740, the first electronic device 100 may determine whether a specified event associated with the first object occurs. For example, the first electronic device 100 may determine whether a user input to the first object is received. For another example, whether the connection with at least one external electronic device registered or not registered at the first application is made over a network while the second application is executed may be determined.

According to an embodiment, when the specified event associated with the first object occurs, in operation 1750, the first electronic device 100 may display a second object associated with the event in the display. For example, when a user input to the first object is received, the first electronic device 100 may display the second object corresponding to the first object (or a currently selected function). For another example, when connected with the external electronic device registered at the first application over the network while the second application is executed, the first electronic device 100 may display the second object for selecting the external electronic device which will output content. For another example, when connected with the external electronic device not registered at the first application over the network while the second application is executed, the first electronic device 100 may display the second object providing notification that the registration of the unregistered external electronic device at the first application is possible.

At least a part of a device (e.g., modules or functions thereof) or a method (e.g., operations) according to various embodiments may be implemented by an instruction stored in a computer-readable storage medium in the form of a program module. The instruction, when executed by a processor, may cause the processor to perform a function corresponding to the instruction. The computer-readable recording medium may include a hard disk, a floppy disk, a magnetic media (e.g., a magnetic tape), an optical medium (e.g., a compact disc read only memory (CD-ROM) and a digital versatile disc (DVD), a magneto-optical media (e.g., a floptical disk)), an embedded memory, or the like. The instruction may include a code made by a complier or a code executable by an interpreter.

While the present disclosure has been shown and described with. reference to various embodiments thereof, it will be understood by hose skilled in the at that various changes in form and details may be made therein without departing from the spirit and scope of the present disclosure as defined by the appended claims and their equivalents.

1. An electronic device comprising:
a display; and
a processor configured to:
display an execution screen of a first application in the display;
change the execution screen of the first application to an execution screen of a second application; and
display a first object provided by the first application on the execution screen of the second application,
wherein the first object is an object for controlling a plurality of functions which are provided by the first application with regard to the second application

2. The electronic device of claim 1, wherein the first application is an application controlling at least one external electronic device for outputting content provided by the second application, and
wherein the second application is a content providing application.

3. The electronic device of claim 1, wherein the plurality of functions includes at least two of a function of changing an application execution screen, a function of controlling an external electronic device for outputting content provided by the second application, a voice recognition function, and a function of changing an environment setting value of the electronic device.

4. The electronic device of claim 3, wherein the function of controlling the external electronic device includes at least one of a function of changing a name of the external electronic device, a function of grouping a plurality of external electronic devices, and a function of removing the grouping, and a function of changing an external electronic device included in a group.

5. The electronic device of claim 1, wherein the first object includes a plurality of first objects corresponding to the plurality of functions, and
wherein the processor is configured to:
select one of the plurality of functions; and
display a first object corresponding to the selected function among the plurality of first objects,

6. The electronic device of claim 5, further comprising:
an input module configured to receive a user input,
wherein the processor is configured to:
when a user input changing the selected function is received through the input module, display a first object corresponding to the changed function among the plurality of first objects.

7. The electronic device of claim 5, further comprising:
an input module configured to receive a user input,
wherein the processor is configured to:
when a user input to a first object corresponding to the selected function is received through the input module, display a second object for controlling the selected function.

8. The electronic device of claim 1, wherein the processor is configured to:
When a connection with at least one external electronic device registered at the first application is made over a network while the second application is executed, display a second object for selecting an external electronic device which will output content.

9. The electronic device of claim wherein the processor is configured to:
when a connection with an external electronic device not registered at the first application is made over a network while the second application is executed, display a second object providing notification that registration of the unregistered external electronic device at the first application is possible.

10. A controlling met od of an electronic device, the method comprising:
displaying an execution screen of a first application in a display;
changing the execution screen of the first application to an execution screen of a second application; and
displaying a first object provided by the first application on the execution screen of the second application,
wherein the first object is an object for controlling a plurality of functions which are provided by the first application with regard to the second application.

11. The method of claim 10, wherein the first application is an application controlling at least one external electronic device for outputting content provided by the first application , and
wherein the second application is a content providing application.

12. The method of claim 10, wherein the plurality of functions includes at least two of a function of changing an application execution screen, a function of controlling an external electronic device for outputting content provided by the second application, a voice recognition function, and a function of changing an environment setting value of the electronic device.

13. The method of claim 12, wherein the function of controlling the external electronic device includes at least one of a function of changing a name of the external electronic device, a function of grouping a plurality of external electronic devices, and a function of removing the grouping, and a function of changing an external electronic device included in a group.

14. The method of claim 10, wherein the first object includes a plurality of first objects corresponding to the plurality of functions, and
wherein the displaying of the first object includes:
selecting one of the plurality of functions; and
displaying a first object corresponding to the selected function among the plurality of first objects.

15. The method claim 14, wherein the displaying of the first object further includes:
receiving a user input changing the selected function through an input module; and
displaying a first object corresponding to the changed function among the plurality of first objects.
